(19) United States
(12) Patent Application Publication
(10) Pub. No.: US 2014/0210378 A1
(43) Pub. Date: Jul. 31, 2014

(54) LAMP

(71) Applicant: Roger Lionel David Sparrow, West Sussex (GB)

(72) Inventor: Roger Lionel David Sparrow, West Sussex (GB)

(21) Appl. No.: 14/238,355

(22) PCT Filed: Sep. 7, 2012
(86) PCT No.: PCT/GB2012/000699

§ 371 Date: Mar. 1, 2014

(30) Foreign Application Priority Data
Sep. 7, 2011 (GB) 1115450.7

(51) Int. Cl. H05B 33/08

(52) U.S. Cl. CPC H05B 33/0884
USPC 315/309

(57) ABSTRACT

A lamp powered by batteries 4 has an LED 5 mounted on an emitter plate 51. The lamp has a temperature measuring circuit (20, FIG. 2) and a power management circuit 11 including an integrated circuit (12, FIG. 2) for control of the output of the lamp.

The present invention relates to a lamp and in particular a battery-powered, LED (light emitting diode) lamp.

LEDs suffer from a known phenomenon, namely thermal run-away. In use, although efficient in terms of lumens of light generated per Watt consumed, LEDs nevertheless generate heat. As their temperature rises, their resistance drops, with the result that current through them rises. More heat is dissipated leading to more temperature etc. Techniques for controlling current to avoid thermal runaway are known.

For instance, in our UK patent application No 2,462,935 9 (Our Earlier Application), an LED lamp is described whose output can be stepped between different levels of output. In use stepping from one level to another is clearly perceptible. A temperature measurement circuit is provided, whereby if the temperature exceeds a threshold, the lamp output is stepped down to the next threshold down. In practice, this is between high power and medium power. The perceptible reduction in power in these circumstances is an irritation to the user, particularly a pedal cyclist working hard and wanting to see where he is going.

The object of the present invention is to provide an improved LED lamp.

For completeness it should be noted that the invention of Our Earlier Application related to the ability to draw power from a lamp's battery for external use. As such it's invention was claimed as:

A lamp adapted to power itself and an external device from its own internal battery, the lamp comprising:

a housing;

a light emitting device mounted on the housing;

a battery mounted within the housing;

a port for charging the battery mounted on the housing;

a switch for switching on/off the light emitting device;

means for supplying electric current from the battery for external use.

According to the present invention there is provided a lamp comprising:

a housing;

a light emitting device mounted on the housing;

a battery mounted within the housing;

means for switching on/off the light emitting device;

a sensor for sensing the temperature of the light emitting device;

means for incrementally reducing current to the light emitting device in the event of the temperature of the light emitting device exceeding a threshold.

Preferably the incremental current reduction means will be an electronic circuit adapted to control current to the light emitting device by variation of the duty cycle of a chopped drive voltage to the device, i.e. the proportion of the time the voltage is applied. Normally the incremental reduction adaptation will be in addition to step reduction adaptation whereby the output of the lamp can be stepped between different levels of output power.

Preferably the incremental current reduction means is adapted to:

determine whether the temperature of the light emitting device has exceeded a first temperature threshold value, typically 42° C., and a second higher temperature threshold value, typically 44° C.;

to reduce incrementally the current to the light emitting device in the event that the first temperature threshold is reached; and

to sequentially increase the reduction until the temperature of the light emitting device stabilises between the first and second temperature thresholds values.

Normally the incremental current reduction means is adapted to a stop incrementally reducing the current in the event that a minimum threshold output power/brightness is reached, typically 10%.

Normally the body/housing is adapted to heat up with dissipated heat from the light emitting device light emitting device. Preferably the Light emitting device will be mounted on a thermally conductive emitter plate, the light emitting device being in thermal contact with and in electrical isolation from the plate. Typically the temperature sensor will be mounted remotely from the light emitting device.

Preferably the light emitting device is an LED, mounted on a metallic disc with electrical insulation from the disc, whereby the entire lamp heats up with LED dissipated heat and the temperature sensor can be mounted remotely from the LED.

Further, the switching means will normally be a push button switch. However other switches such as an inertial switch are possible.

To help understanding of the invention, a specific embodiment thereof will now be described by way of example and with reference to the accompanying drawings, in which:

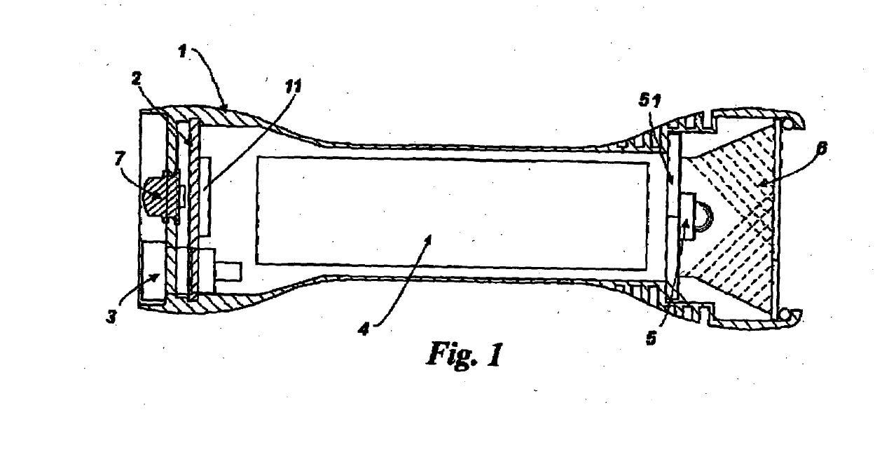

FIG. 1 is a diagrammatic cross-sectional view of a lamp in accordance with the invention;

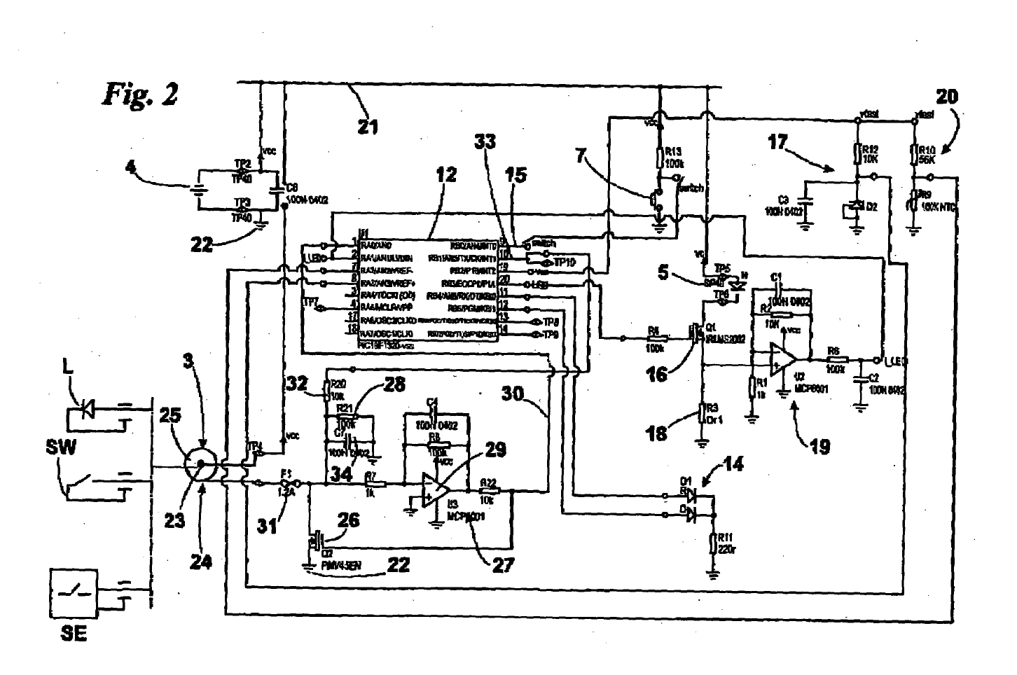

FIG. 2 is a circuit diagram of the lamp of FIG. 1.

Referring to the drawings, of which FIGS. 1 and 2 are re-numbered ones from Our Earlier Application. Most of the physical features of the lamp of the preferred embodiment of that application are used in the preferred embodiment of the lamp of the present invention. For completeness, the description with reference to the drawings of Our Earlier Application is repeated below in italics—omitting certain detail irrelevant for present purposes.

A lamp has a body 1, in which is mounted a printed circuit board (PCB) 2, to which is connected amongst other components a charging port 3. A battery 4 is housed in the body, which also carries a light emitting diode 5 and a reflector 6 at the end opposite from the port 3. Adjacent the port is a press button switch 7. FIG. 1 is diagrammatic, insofar for instance as wiring is not shown.

A power management circuit 11, mounted in physical form on the PCB 2, has a programmed microprocessor/integrated circuit (IC) 12 of the PIC18F1320-1/SS type. It is programmed in accordance with the description below, but could be programmed with differences in detail.

The port 3, the battery 4, the LED 5 and the switch 7 are connected to the circuit. The switch incorporates a bi-colour LED 14 powered by the IC 12 to indicate battery state and the state of powering of the lamp. The switch itself is connected to ground an input terminal 15 of the IC for controlling it.

The LED is switched on by applying a voltage to the base of a switching field effect transistor 16 in series with its earth connection. Brightness of the LED is controlled by pulse width modulation, that is controlling proportion of the time that it is switched on, that is the proportion of the time that current is actually flowing through it. To maintain the brightness constant, the IC is provided with a battery voltage measuring circuit 17 and is programmed to adjust the pulse width of current supply for desired brightness. The actual current is measured in terms of voltage across a resistor 18 in series with the transistor 16, the voltage being measured by an amplifier circuit 19 and fed back to the IC 12 for control of the pulse width. A temperature measuring circuit 20 is provided to reduce the current in the event of LED resistance drop to avoid thermal run away. The IC 12 can be programmed to reduce the brightness in event that the temperature rises unacceptably.

The battery is connected between a positive voltage line 21 and local earth 22 in the lamp. The central contact 23 of the port 24 is connected to the voltage line 21, i.e. to the positive battery terminal, but the outer contact 25 is not connected directly to earth. This is to protect the battery from accidental short-circuiting. In order to allow the battery to be charged, a field effect transistor switch 26 is provided, associated with a detection circuit 27. Normally the outer contact will be grounded via a high resistance (100 k) 28. When a charger voltage C, as opposed to a short circuit, is applied to the port 3, the input to the operational amplifier 29 in the detection circuit will have the polarity of its inputs reversed. It will change state, causing a positive voltage on its output and activate the switch 26 to provide a return path for the charging current via the local earth. The positive voltage is passed to the IC on line 30, causing the switch LED 14 to flash green, indicating charging. The lamp can still be used in this state, as when it is being used in conjunction with a back-up battery pack (not shown).

If an auxiliary load L is applied to the port, a route to ground is provided via the resistance 28. Thus a low voltage is applied across the load, assuming the load to be of lower resistance than the resistance 28.

The IC 12 can be controlled by operation of the switch to apply a voltage on line 30 switch on the transistor 26. Thus the load can be powered at full battery voltage. A fuse 31 is provided to protect against excessive current drain. Where as preferred the battery is a Lithium Ion battery it will be provided with its own internal battery protection circuit.

By way of example, the lamp can have the following switch actuation protocol:

1. Double click to switch ON at full brightness—switch LED green;
2. Single subsequent click to medium brightness—switch LED orange;
3. Single subsequent click to low brightness—switch LED red;
4. Single subsequent click to full brightness—switch LED green;
5. Long subsequent click to flash—switch LED green;
6. Held subsequent click to switch off

In accordance with the present invention, LED 5 is mounted on an emitter plate 51, an aluminum disc, with the LED 5 in electrical isolation from the plate 51. The body/housing 1 of the lamp is also formed of aluminum and the emitter plate 51 is secured to the housing in thermal contact with the housing.

Temperature measuring circuit 20 is mounted on PCB 2, remote from the light emitting diode 5 and emitter plate 51, at the opposite end of the body 1 to the LED 5 and the emitter plate 51.

In operation of the lamp, as the temperature of the LED increases, heat from the LED is dissipated from the LED via the emitter plate 51 and the body/housing 1. As the emitter plate 51 and body/housing 1 conduct heat away from the LED, the overall temperature of the entire lamp is increased.

The IC 12 is programmed to sense whether the temperature of the lamp, and hence the LED 5, has exceeded a first threshold and a second slightly higher threshold. These thresholds are typically 42° C. and 44° C., the temperatures between which the LED is most efficient in terms of production of lumens per watt.

Further it is programmed to reduce incrementally the duty cycle of the drive voltage to the LED, to reduce the average current through it in the event that the first temperature threshold is reached. The reduction is sequentially increased until the temperature stabilises between the thresholds. In particularly hot climates, the incremental reduction may be needed down past 90% of full brightness to avoid over-heating of the LEDs, possibly down past medium brightness and indeed incremental reduction down to 10% of full brightness is provided for. This latter provision is to ensure that the light stays ON and reassures the user that it is on, even if he/she is using the lamp on a bicycle in a hot climate and has stopped, resulting in no cooling airflow past the lamp.

1. A lamp comprising:
a housing;
a light emitting device mounted on the housing;
a battery mounted within the housing;
means for switching on/off the light emitting device;
a sensor for sensing the temperature of the light emitting device;
means for incrementally reducing current to the light emitting device in the event of the temperature of the light emitting device exceeding a threshold.

2. A lamp as claimed in claim 1, wherein the incremental current reduction means is an electronic circuit adapted to control current to the light emitting device by variation of the duty cycle of a chopped drive voltage to the device.

3. A lamp as claimed in claim 1, wherein the incremental current reduction means is adapted to:
determine whether the temperature of the light emitting device has exceeded a first temperature threshold value and a second higher temperature threshold value;
to reduce incrementally the current to the light emitting device in the event that the first temperature threshold is reached; and
to sequentially increase the reduction until the temperature of the light emitting device stabilises between the first and second temperature thresholds values.

4. A lamp as claimed in claim 3, wherein the first temperature threshold value is approximately 42° C. and/or wherein the second temperature threshold value is approximately 44° C..

5. A lamp as claimed in claim 1, wherein the incremental reduction adaptation is in addition to a step reduction adaptation whereby the output of the lamp can be stepped between different levels of output power.

6. A lamp as claimed in claim 1, wherein the incremental current reduction means is adapted to a stop incrementally reducing the current in the event that a minimum threshold output power/brightness is reached.

7. A lamp as claimed in claim 6, wherein the minimum threshold output power/brightness is approximately 10% of the full normal operating power/brightness.

8. A lamp as claimed in claim 1, wherein the housing is adapted to heat up with dissipated heat from the light emitting device.

9. A lamp as claimed in claim 8, wherein the temperature sensor is mounted remotely from the light emitting device.

10. A lamp as claimed in claim 8, wherein the housing is metallic.

11. A lamp as claimed in claim 8, wherein the light emitting device is mounted on a thermally conductive emitter plate and wherein the light emitting device is in thermal contact with and in electrical isolation from the plate.

12. A lamp as claimed in claim 1, wherein the light emitting device is a Light Emitting Diode (LED).

13. A lamp as claimed in claim 1 wherein the switching means is a push button switch.

14. A lamp as claimed in claim 1, wherein the switching means is an inertial switch.

15. (canceled)

16. (canceled)

17. (canceled)

18. (canceled)

19. (canceled)

20. (canceled)

21. (canceled)
